(19) United States
(12) Patent Application Publication
(10) Pub. No.: US 2015/0306853 A1
(43) Pub. Date: Oct. 29, 2015

(54) MULTI-LAYER FOILS COMPRISING PLASTICIZED POLYVINYL ACETAL, FEATURING PENETRATION RESISTANCE AND SOUND-DAMPING PROPERTIES

(71) Applicant: KURARAY EUROPE GMBH, Hattersheim (DE)

(72) Inventors: Jan BEEKHUIZEN, Troisdorf (DE); Uwe KELLER, Bonn (DE)

(21) Appl. No.: 14/443,323

(22) PCT Filed: Nov. 13, 2013
(86) PCT No.: PCT/EP2013/073691

§ 371 Date: May 15, 2015

(30) Foreign Application Priority Data
Nov. 16, 2012 (EP) 12193078.8

(51) Int. Cl. B32B 27/30; B32B 27/22; B32B 27/08

(52) U.S. Cl. CPC B32B 27/306; B32B 27/08; B32B 27/22

(57) ABSTRACT

The invention relates to an intermediate layer film for laminated glazing, constructed from at least one first and at least one second sub-film containing plasticiser-containing polyvinyl acetal each with different plasticiser content, wherein the first sub-film consists of plasticiser-containing polyvinyl acetal with a polyvinyl alcohol content from 17 to 22% by weight, and the second sub-film consists of plasticiser-containing polyvinyl acetal with a polyvinyl alcohol content from 11 to 14% by weight, and the intermediate layer film has a total plasticiser content of less than 28% by weight. The film can be used in particular for windscreens with use of glasses with a total thickness of less than 3.7 mm.

### CROSS-REFERENCE TO RELATED APPLICATIONS

This application is the U.S. National Phase of PCT Appln. No. PCT/EP2013/073691 filed Nov. 13, 2013, which claims priority to European Application No. EP 12193078.8 filed Nov. 16, 2012, the disclosures of which are incorporated in their entirety by reference herein.

### BACKGROUND OF THE INVENTION

1. Field of the Invention

The invention relates to a plasticiser-containing film that is suitable as a sound-damping intermediate layer in laminated glass, has good penetration properties, and is constructed from at least two sub-films based on plasticiser-containing polyvinyl acetals with different polyvinyl alcohol content.

2. Description of the Related Art

Laminated glasses generally consist of two glass panes and an intermediate film connecting the glass panes. Plasticiser-containing partly acetalised polyvinyl alcohol (polyvinyl acetal), in particular polyvinyl butyral (PVB), is used predominantly as the film material. Laminated glasses (LGs) are used for example as windscreens or side glass panels in the automotive field and also as safety glazing in the construction field.

A feature of laminated glazing that is becoming increasingly important is the sound-damping properties of such glass. This can be achieved for example by a particularly soft and therefore sound-absorbing intermediate layer film. These films, however, are mechanically often insufficiently stable or do not have sufficient adhesion properties.

Alternatively, multi-layer systems can be used, wherein the sub-layers differ in terms of their mechanical strengths and sound damping is thus achieved by mechanical decoupling.

Different mechanical strengths of films based on plasticiser-containing polyvinyl acetal can be set for example by the plasticiser content thereof or by the proportion of polyvinyl alcohol or polyvinyl acetate groups in the polyvinyl acetal.

EP 2153989 A1 or U.S. Pat. No. 5,340,654 thus describe multi-layer films in which a first sub-layer contains a polyvinyl acetal with a high residual acetate content and a second sub-layer contains a polyvinyl acetal with a lower residual acetate content. Due to the different residual acetate contents, one of the sub-films can have a high plasticiser content and the other can have a lower plasticiser content, whereby different mechanical strengths of the sub-films result.

WO 2006/102049 discloses a similar multi-layer system, in which two sub-films comprise polyvinyl acetal with an identical residual acetate content, but different proportion of polyvinyl alcohol groups. Here also, a different plasticiser content and therefore different mechanical strengths of the sub-films are provided.

Due to the soft sub-film, the multi-layer films described here do have sound-damping properties, but are mechanically more unstable due to the high total plasticiser content of more than 29% by weight, which has a negative effect, for example on the penetration resistance of a glass/glass laminate (for example a windscreen) produced therewith.

These multi-layer films are suitable for use as sound-absorbing films in conventional windscreens or building glazing. The windscreens conventionally used in the automotive industry usually have a total thickness (in relation to glass) of more than 3.7 mm.

It is currently an objective of the automotive industry to limit the CO₂ emission of motor vehicles and/or to reduce the fuel consumption thereof. Here, the reduction of the overall weight of motor vehicles plays a key role. The reduction of the weight of the glazing may also contribute to the reduction of the overall weight of motor vehicles. With use of thinner glass for windscreens, a number of kilograms of weight are thus saved.

A disadvantage of this glass thickness reduction is that the sound-damping properties of the windscreens deteriorate as a result. This is caused on the one hand by the nominal loss of glass mass (mass law) and on the other hand by the shift of coincidence dips to higher frequencies. The human ear is particularly perceptible in the regions 1000-5000 Hz, which corresponds to the frequency range of the human voice. The reduced sound damping of the windscreens is enormously disadvantageous for the comfort of passengers. In addition, laminates made of thinner panes have lower penetration resistance, in particular with the use of sound-damping films with lower mechanical strength per se.

### SUMMARY OF THE INVENTION

An object of the present invention was therefore to produce intermediate layer films for laminated glazing with sound-damping properties that have good damping properties with sufficient rigidity, that is to say sufficient penetration resistance, and are therefore suitable for production, for example, of windscreens with thinner glasses in a thickness below 3.7 mm (in relation to the total thickness of the two individual panes).

It has now been surprisingly and unexpectedly discovered that intermediate layer films based on plasticiser-containing polyvinyl acetal that comprise sub-layers made of polyvinyl acetal with different polyvinyl alcohol content and low total plasticiser contents have sufficient rigidities or penetration resistance in spite of good damping properties.

### DETAILED DESCRIPTION OF THE PREFERRED EMBODIMENTS

The present invention therefore relates to an intermediate layer film for laminated glazing, said film being constructed from at least one first and at least one second sub-film containing plasticiser-containing polyvinyl acetal each with different plasticiser content, wherein the first sub-film consists of plasticiser-containing polyvinyl acetal with a polyvinyl alcohol content from 17 to 22% by weight, and the second sub-film consists of plasticiser-containing polyvinyl acetal with a polyvinyl alcohol content from 11 to 14% by weight, and the intermediate layer film has a total plasticiser content of less than 28% by weight.

A second sub-film is preferably arranged in the intermediate layer film between two first sub-films.

The total plasticiser content of the intermediate layer film is understood hereinafter to mean the content of plasticiser, in relation to the total weight of the film.

Mechanical stability (i.e. total plasticiser content) and damping properties of intermediate layer film are described in the literature as mutually exclusive properties or at least incompatible properties. EP2153989 A1 thus discloses intermediate layer films with good damping properties, but a high total plasticiser content of more than 29% by weight. The present Comparative example 1 corresponds to Example 2c in EP2153989 A1. It shows that this film is mechanically less resistant than films according to the invention.

Intermediate layer films according to the invention preferably have a total plasticiser content from 28% by weight to 24% by weight, more preferably from 27% by weight to 24% by weight, and in particular from 26% by weight to 24% by weight.

The difference of films according to the invention from the currently obtainable soundproofing films based on plasticised polyvinyl acetal lies in the increased mechanical rigidity thereof and the associated penetration resistance. To this end, the films are provided by suitable combinations of the sub-layers as intermediate layer films based on plasticised polyvinyl acetal.

A particular feature is that the films here have a low total plasticiser content, which actually appears to be contradictory to the application as sound-damping film.

The sound-damping effect of the films according to the invention should be maximal at the application temperatures of the subsequent glass laminate. In the case of automotive glazing, the application temperatures lie at approximately 20° C., since the pane is heated in winter and is cooled in summer by air-conditioning systems. Films according to the invention, in accordance with ISO 16940, preferably have maximum damping in the temperature range of 15-25° C. Here, the damping is specified in the form of the loss factor according to ISO 16940 and constitutes a measure for how well the film can damp the incoming sound, more specifically how well it can convert said sound into heat (thermal dissipation).

A laminate produced from the intermediate layer film and two glass panels 2 mm thick has
a) a natural frequency of the 2^{nd} mode in accordance with ISO 16940 of more than 750 Hz at 20° C. and
b) a loss factor of the 2^{nd} mode in accordance with ISO 16940 of at least 0.25 at a temperature of 20° C.

A laminate produced from a film according to the invention and two glass panels 2 mm thick preferably has, at a temperature of ° C., a natural frequency of the 2^{nd} mode measured in accordance with ISO 16940 of more than 780 Hz and in particular more than 800 Hz.

A laminate produced from a film according to the invention and two glass panels 2 mm thick preferably has loss factors for the 2^{nd} mode at 10° C., measured in accordance with ISO 16940, of more than 0.15, more preferably of more than 0.3 and most preferably of more than 0.35. The loss factors for the 2^{nd} mode are preferably more than 0.25 at 30° C.

A laminate produced from a film according to the invention and two glass panels 2 mm thick preferably has a natural frequency of the 1^{st} mode according to ISO 16940 of more than 160 Hz at 20° C. Here, the loss factor of the 1^{st} mode at 20° C. preferably has a value of more than 0.2 and more preferably of more than 0.25.

The damping properties (loss factors and natural frequency) are determined in accordance with ISO 16940 on a test body formed from an intermediate layer film 0.76-1.14 mm thick (the damping properties of the film do not change significantly in this thickness range, however the measurement is preferably taken on films with a thickness of 0.84 mm) that has been laminated between two glass panes 2 mm thick. Here, the first two resonance modes n are measured, 1^{st} mode and 2^{nd} mode. The loss factor can be specified here likewise as η1 and η2 of the 1^{st} mode and 2^{nd} mode respectively.

All damping properties of the films according to the invention are measured following production of a test laminate in the conventional autoclave method after a storage time of the glass samples of at least 10 weeks at room temperature.

Films according to the invention present a significant advantage compared to conventional soundproofing films in particular for the lamination with thin glasses, i.e. glass panes such as windscreens, with a total thickness of less than 3.7 mm, preferably less than 3.5 mm, and more preferably less than 3.3 mm. Films according to the invention can be used in particular to produce laminates having asymmetrical glass thicknesses. For example, one glass pane may thus have a thickness of 1.8 mm, and the second glass pane may have a thickness of 1.4 mm. Such asymmetric laminates additionally have sound-damping properties.

The intermediate layer film according to the invention may preferably have one or more first sub-films formed from plasticiser-containing polyvinyl acetal with a polyvinyl alcohol content of 18-21% by weight, and more preferably of 19.5-20.5% by weight. The first sub-film optionally comprises plasticiser-containing polyvinyl acetal with a proportion of polyvinyl acetate groups from 0.1 to 11 mol %, preferably 0.1 to 5 mol %, and most preferably 0.1-2 mol %.

The intermediate layer film according to the invention may preferably comprise one or more second sub-films formed from plasticiser-containing polyvinyl acetal with a polyvinyl alcohol content of 11-13.5% by weight, and more preferably of 11.5-13% by weight. The second sub-film optionally comprises plasticiser-containing polyvinyl acetal with a proportion of polyvinyl acetate groups from 0.1 to 11 mol %, preferably 1-9 mol %, and most preferably 5-8 mol %.

Sound-damping intermediate layer films are usually very soft or contain at least one layer that is very soft compared to the other layers of the film laminate. Such films have a low glass transition temperature and have low rigidity. By contrast, films according to the invention have very good penetration properties in spite of good sound damping.

The penetration properties of laminated glass can be determined for example in accordance with ECE43 (ball-drop test). Here, films according to the invention based on plasticised polyvinyl acetal with a thickness of 0.76 mm are laminated between 2 mm float glass and a steel ball weighing 2.26 Kg is dropped onto a predefined sheet measuring 30×30 cm. The drop height to be specified is the height at which the glass reliably holds off the ball. The greater the drop height, the better the penetration strength.

An improved penetration strength can be obtained by the use of thicker films. For conventional soft sound-damping films, it is therefore necessary to increase the film thickness for sufficient penetration strength. However, this leads to higher material use and costs.

Besides the film thickness, the adhesion of the film to glass plays a key role for the penetration strength. With constant film thickness, films with low glass adhesion usually demonstrate a better penetration strength than films with high glass adhesion. The adhesion to glass is usually determined by what is known as the Pummel test.

A laminate produced from films according to the invention 0.76 mm thick and two glass panels 2 mm thick preferably has a penetration strength in the ball drop according to ECE43 of at least 5.00 m, more preferably of at least 5.25 m, and in particular of at least 5.5 m. The penetration properties were determined with films with Pummel adhesion 3-5.

The films according to the invention, compared to known soundproofing films of identical total thickness, therefore, besides good sound-damping properties, also have improved penetration properties according to ECE-43.

With the use of intermediate layer films that consist of a number of sub-films formed from plasticiser-containing, but different polyvinyl acetals, it should also be noted that the film properties can still change over time.

This is due to the fact that the compatibilities of polyvinyl acetal films and given plasticiser or plasticiser system are dependent on the respective proportions of polyvinyl acetal groups, polyvinyl alcohol groups and polyvinyl acetate groups as well as temperature. In particular, the proportion of polar polyvinyl alcohol groups heavily influences the plasticiser compatibility. Following lamination in the usual autoclave processes, i.e. influence of temperatures of above 100° C. over at least one hour, there is thus usually a plasticiser migration between the sub-layers.

The plasticiser migration can therefore lead to a change in properties over time, for example the mechanical properties such as rigidity or tensile modulus, but in particular the natural frequencies of the various modes measured in accordance with ISO 16940 can change.

This can lead to disadvantageous effects, for example a worsening of the sound-damping properties at certain temperatures or frequencies. Films according to the invention therefore present the desired properties in the equilibrium state, which is achieved following lamination after a storage time of 10 weeks at room temperature. The equilibrium state is generally achieved after just 6, 7, 8 or 9 weeks of storage time at room temperature, and can be easily determined by comparative measurements.

The films according to the invention are preferably composed of at least two sub-films, wherein at least one first sub-film (A) preferably contains a polyvinyl acetal with a proportion of polyvinyl acetate groups between 0.1 and 11 mol %, more preferably 5 and 8 mol %, and at least one second sub-film (B) preferably contains a polyvinyl acetal with a proportion of polyvinyl acetate groups from 0.1 to 11 mol %, more preferably 0.1-4 mol %, and most preferably 0.1-2 mol %.

The sub-films can be combined in the order A/B/A or B/A/B. The sub-films can each be used in practically any thickness, provided the soundproofing properties do not change negatively. All sub-films may therefore have the same thickness, however combinations of sub-films of different thickness are also possible.

With the preferred arrangement of the intermediate layer film according to the invention as triple laminate A/B/A, the external films A have largely the same thickness, whereas the sound-damping film B can be as thin as possible, for example 100-200 μm. In the case for example of an intermediate layer film in the triple composite A/B/A with a total thickness of 0.84 mm, the inner, sound-damping layer B may thus have a thickness of 100-200 μm, and the outer layers may accordingly have a thickness from 320 to 375 μm. This has the advantage that, in a corresponding glass/glass laminate, the sides of the multi-layer film directed toward the glass have the same adhesion properties. The middle film within the scope of the present invention then serves as a second sub-film and has the specified properties.

Intermediate layer films according to the invention preferably have a total thickness from 0.5 mm to 1.14 mm, preferably 0.6 to 1 mm, and most preferably 0.76 to 0.9 mm.

The compatibility of plasticiser and partly acetalised polyvinyl alcohol generally reduces with the decrease of the polar nature of the plasticiser. Plasticisers of higher polarity are thus more compatible with polyvinyl acetal than plasticisers of lower polarity. Alternatively, the compatibility of plasticisers of low polarity rises with an increase of the degree of acetalisation, i.e. with decrease of the number of hydroxyl groups and therefore the polarity of the polyvinyl acetal.

Due to the different proportions of polyvinyl alcohol groups, the sub-films can accommodate different quantities of plasticisers, without resulting in a bleeding of the plasticiser. The sub-films therefore preferably have plasticiser contents differing by at least 5% by weight, more preferably at least 7.5% by weight, and in particular by at least 10% by weight, in relation to the film formulation.

In particular, the intermediate layer film according to the invention may have one or more first sub-films with a plasticiser content from 20 to 27% by weight and one or more second sub-films with a plasticiser content from 30 to 38% by weight.

The plasticiser contents are determined, similarly to the damping properties, following lamination of the film between two glass panes in a conventional autoclave process and after a storage time of at least 10 weeks.

Intermediate layer films according to the invention can be produced by combining individually extruded sub-films or preferably by co-extrusion of the sub-films. The sub-films, prior to the combination with one another, may contain identical or different plasticisers in an identical or different quantity. The use of identical plasticisers is preferred, wherein the composition of plasticiser mixtures in the sub-films may change slightly on account of migration.

The sub-films may contain plasticisers or plasticiser mixtures formed from at least one of the following plasticisers known for PVB film: di-2-ethylhexyl sebacate (DOS), di-2-ethylhexyl adipate (DOA), dihexyl adipate (DHA), dibutyl sebacate (DBS), triethylene glycol bis-n-heptanoate (3G7), tetraethylene glycol bis-n-heptanoate (4G7), triethylene glycol bis-2-ethylhexanoate (3GO or 3G8), tetraethylene glycol bis-n-2-ethylhexanoate (4GO or 4G8), di-2-butoxyethyl adipate (DBEA), di-2-butoxyethoxyethyl adipate (DBEEA), di-2-butoxy-ethyl sebacate (DBES), di-2-ethylhexyl phthalate (DOP), di-isononyl phthalate (DINP), triethylene glycol bis-isononanoate, triethylene glycol bis-2-propylhexanoate, 1,2-cyclohexane dicarboxylic acid diisononyl ester (DINCH), tris(2-ethylhexyl)phosphate (TOF) and dipropylene glycol benzoate.

In addition, the sub-films according to the invention may contain further additives known to the person skilled in the art, such as residual quantities of water, UV absorbers, antioxidants, adhesion regulators, optical brighteners, stabilisers, dyes, processing aids, organic or inorganic nanoparticles, pyrogenic silicic acid and/or surface-active substances.

In a variant of the invention, all sub-films have the specified additives in largely identical concentration. In a preferred variant of the invention at least one of the sub-films does not comprise any adhesion regulators (non-stick agents). Within the scope of the present invention, non-stick agents are understood to mean compounds with which the adhesion of plasticiser-containing polyvinyl acetal films to glass surfaces can be adjusted. Compounds of this type are known to the person skilled in the art; in practice, alkaline or alkaline earth metal salts of organic acids, such as potassium/magnesium acetate, are often used for this purpose.

It is also possible for a least one of the sub-films to contain 0.001 to 20% by weight SiO₂, preferably 1 to 15% by weight, in particular 5 to 10% by weight, optionally doped with Al₂O₃ or ZrO₂, in order to improve rigidity.

In order to produce polyvinyl acetal, polyvinyl alcohol is dissolved in water and is acetalised with an aldehyde such as butyraldehyde, with addition of an acid catalyst. The precipitated polyvinyl acetal is separated off, washed neutral, optionally suspended in an alkaline aqueous medium, then washed neutral again and dried.

The polyvinyl alcohol content of the polyvinyl acetal can be adjusted by the quantity of the aldehyde used during acetalisation. It is also possible to perform the acetalisation with other or a number of aldehydes having 2-10 carbon atoms (for example valeraldehyde).

The films based on plasticiser-containing polyvinyl acetal preferably contain uncrosslinked polyvinyl butyral (PVB), which is obtained by acetalisation of polyvinyl alcohol with butyraldehyde.

The use of crosslinked polyvinyl acetals, in particular crosslinked polyvinyl butyral (PVB), is also possible. Suitable crosslinked polyvinyl acetals are described for example in EP 1527107 B1 and WO 2004/063231 A1 (thermal self-crosslinking of polyvinyl acetals containing carboxyl groups), EP 1606325 A1 (polyvinyl acetals crosslinked with polyaldehydes) and WO 03/020776 A1 (polyvinyl acetals crosslinked with glyoxylic acid). The disclosure of these patent applications is incorporated herein fully by reference.

Within the scope of the present invention, terpolymers formed from hydrolysed vinyl acetate/ethylene copolymers can also be used as polyvinyl alcohol. These compounds are generally hydrolysed to more than 92 mol % and contain 1 to 10% by weight of units based on ethylene (for example of the type “Exceval” from Kuraray Europe GmbH).

Within the scope of the present invention, hydrolysed copolymers formed from vinyl acetate and at least one further ethylenically unsaturated monomer can also be used as polyvinyl alcohol.

The polyvinyl alcohols within the scope of the present invention can be used in pure form or in the form of a mixture of polyvinyl alcohols with different degree of polymerisation or degree of hydrolysis. It is possible that the intermediate layer films according to the invention consist of 2, 3, 4 or 5 sub-films, wherein the adjacent sub-films each have the specified different properties.

In order to produce the films according to the invention, the sub-films can first be produced individually by extrusion and then combined mechanically, for example by being rolled jointly onto a film reel in order to form the intermediate layer film according to the invention.

It is also possible to produce the intermediate layer film by simultaneous co-extrusion of the sub-films. The co-extrusion can be performed for example with an appropriately equipped flat film die or a feed-block.

In the automotive field films are often used that have what is known as a colour band in the upper region. To this end, either the upper part of the film can be co-extruded with an accordingly coloured polymer melt, or in a multi-layer system one of the sub-films may have a different colouration. In the present invention this can be achieved by complete or partial dyeing of at least one sub-film.

The films or sub-films according to the invention are generally produced by extrusion or co-extrusion, moreover under certain conditions (melt pressure, melt temperature and die temperature) so as to obtain a melt fracture surface, i.e. a stochastic surface roughness.

Alternatively, an intermediate layer film already produced in accordance with the invention can be embossed with a non-stochastic, regular roughness by means of an embossing process between at least one pair of rolls. Embossed films generally have improved deaeration behaviour during the laminated glass production and are used preferably in the automotive field.

Films according to the invention have, independently of the production method, a surface structure applied on one side or particularly preferably on both sides, said surface structure having a roughness R_{z} from 15 to 150 μm, preferably R_{z} from 15 to 100 μm, more preferably R_{z} from 20 to 80 μm, and in particular R_{z} from 30 to 75 μm.

Films according to the invention are also well suited for the production of glass/film/plastic laminates, for example for permanent bonding of a glass pane to a PET layer. The bonding of two plastic panes, for example made of polycarbonate or PMMA, is also possible with the films according to the invention.

The films according to the invention can be used in particular to produce laminated glass by lamination with one or more glass panes in the manner known to the person skilled in the art. The laminated glass can be used in the automotive field, for example as a windscreen, as well as in the architectural field, for example in windows or transparent façade components, or in furniture making.

A further use of the films according to the invention lies in the production of photovoltaic modules.

The fundamental production and composition of films based on polyvinyl acetals is described for example in EP 185 863 B1, EP 1 118 258 B1, WO 02/102591 A1, EP 1 118 258 B1 or EP 387 148 B1.

### Measurement Methods

The ester number EZ of polyvinyl alcohol was determined in accordance with DIN EN ISO 3681. The degree of hydrolysis HG was calculated from the ester number as follows: HG [mol %]=100*(100−0.1535*EZ)/(100−0.0749*EZ)

The polyvinyl alcohol content and polyvinyl acetate content of PVB were determined in accordance with ASTM D 1396-92. The degree of acetalisation (=butyral content) can be calculated as the remaining portion from the sum of polyvinyl alcohol content and polyvinyl acetate content determined in accordance with ASTM D 1396-92 needed to make one hundred. Conversion from % by weight into mol % is achieved by formulas known to the person skilled in the art.

The plasticiser content of the films was established by dissolving the film in ethanol and by subsequent quantitative gas chromatography. In order to establish the plasticiser content of the individual sub-films, the multi-layer films have to be separated again after a conditioning period of approximately 10 weeks at room temperature, that is to say once plasticiser migration has largely stopped, and measured individually.

### Film Roughness:

The surface roughness R_{z} or the roughness value R_{z} was determined in accordance with DIN EN ISO 4287. The specified measurements were performed using a roughness measuring device from Mahr, type S2, drive unit PKG with mechanical skidded pick-up MFW-250. The cut-off wavelength λ_{c}, the total measurement length lₘ, the number and length of the individual measurement lengths lₑ and the pre-travel and post-travel lengths lᵥ and lₙ respectively were selected in accordance with the above-specified standard.

The glass transition temperature of the partly acetalised polyvinyl alcohol was determined by means of differential scanning calorimetry (DSC) in accordance with DIN 53765 with use of a heating rate of 10K/min at a temperature interval of minus 50° C. to 150° C. A first heating ramp, followed by a cooling ramp, followed by a second heating ramp was used. The position of the glass transition temperature was established on the measurement curve associated with the second heating ramp in accordance with DIN 51007. The DIN midpoint (Tg DIN) was defined as the point of intersection of a horizontal line at half step height with the measurement curve. The step height was defined by the vertical distance of the two points of intersection of the middle tangent with the base lines of the measurement curve before and after glass transition.

### Measurement of the Penetration Properties

The penetration properties of the films were determined by means of the ball-drop test according to ECE43. To this end the films were laminated one layer between 2 panes of float glass 2 mm thick by means of methods known to the person skilled in the art. The panes were 30×30 cm in size. The samples were subjected to the ball-drop test following a storage time of 10 weeks at 20° C. in accordance with ECE43. Here, a steel ball weighing 2.26 Kg contacted the panes, which were fixed in a frame. At least 10 panes of the same film were tested and the drop height at which the ball no longer breaks through the pane was specified. Since adhesion also plays a role in the penetration properties, all panes were tested with the same adhesion level of 3-5 Pummel.

### Measurement of the Damping Behaviour

The damping properties of the films were determined by measuring the mechanical impedance according to ISO 16940. To this end the films were laminated between two glass panes 2 mm thick, and from this a test sample with the dimensions 300×25 mm was cut. Onto this glass sample, a cement stud (type UA 0866/Brüel&Kjaer) was applied in the middle using a cyanoacrylate adhesive, which makes it possible to directly connect the sample via a thread to an impedance head (type 8001/Brüel&Kjaer GmbH). This impedance head allows the simultaneous measurement of force and acceleration at a point of the glass sample over a frequency range of 1-10000 Hz. The impedance head was located directly on the vibration table of a vibration exciter (type 4809/Brüel&Kjaer GmbH), via which the desired forces were transmitted. Both were located in a controllable, isolated heating chamber (Binder), which allows the determination of the damping properties over a temperature range of preferably 0-40° C. Now, noise was generated by means of a noise signal generator (PULSE Front-end Type 3560B-040/Brüel&Kjaer GmbH), which simultaneously functions as signal receiver. The noise was fed via a power amplifier (type 2718/Brüel&Kjaer GmbH) into the vibration exciter. The frequency range here comprised 0 to 5000 Hz. Now, the response of the glass sample to the generated vibrations could be measured at different temperatures directly via the impedance head by means of force/speed recording, and analysed using analysis software (PULSE FFT Analysis type 7770N2/Brüel&Kjaer GmbH). From the determined transfer function of force and acceleration, the different natural frequencies f of the vibration modes n of the glass samples and their half widths can be determined. The half width Δf was chosen here at 3 dB below the signal maximum. Via the relationship η=Δf/f, the loss factor η at the different natural frequencies can be determined. A high loss factor or a high percent damping value is a measure for the quality of the sound-damping properties.

The samples were measured in each case directly, approximately 2 h after the lamination in the autoclave. The finished and measured samples were stored at 20° C. and measured again after weeks. The reason for this is that the properties change over time until they reach their equilibrium state. As described above, this temporal dependency is caused by plasticiser diffusion processes.

Besides the loss factor per se, however, the position, that is to say the magnitude, of the natural frequency of the various resonance modes also plays a key role. The higher these natural frequencies, the more rigid is the glass laminate. This is also expressed by the flexural rigidity B in ISO 16940. It is clear from the equation for B that at higher natural frequency the flexural rigidity is also greater in the corresponding resonance mode, since f˜B in the respective mode. For the preferred use in thin windscreens, for example less than 3.7 mm (in relation to the pure glass thickness without film), but preferably less than 3.5 mm and more preferably less than 3.3 mm glass, the films must compensate for the loss of glass thickness and therefore also rigidity in certain parts, but without losing their good sound-damping properties in the process.

Films according to the invention thus have a natural frequency of the 2^{nd} mode at 20° C. of more than 750 Hz and preferably more than 780 Hz and most preferably more than 800 Hz with loss factors of more than 0.25, preferably more than 0.3 and most preferably more than 0.35.

Since the damping properties of a material are dependent on temperature, the samples were measured in a selected temperature range of 10-30° C. (10° C. interval), which in principle covers the field of application of sound-absorbing glass.

### EXAMPLES

The polyvinyl butyrals used were produced in the conventional manner known to the person skilled in the art and had the chemical composition and mechanical properties specified in the tables. The damping properties were determined following lamination in an autoclave process and after 10 weeks of storage of the laminates at room temperature.

Different variants of the films according to the invention are presented in Examples 1-6. It is clear that a natural frequency of the 2^{nd} mode according to ISO 16940 of more than 750 Hz with loss factors of more than 0.25 can be set by selective adjustment of the plasticiser content below 28% by weight with different combinations of the sub-films.

Here, films according to the invention also demonstrate very good penetration properties compared to conventional soundproofing films, as shown by Comparative example 1.

Tables 3 and 4 show the effects of the migration of the plasticiser. The films according to the invention demonstrate the desired damping properties only after a waiting period due to the migration of the plasticiser (Table 4 compared with Table 3).

Comparative example 2 presents a usual film, not according to the invention, based on sub-film B1. This film indeed also demonstrates good penetration properties, but compared to films according to the invention does not have any damping properties in respect of sound according to ISO 16940 and therefore also cannot be utilised for a soundproofing film.

Films according to the invention are therefore particularly suited for the use with thin glasses.

TABLE 1

| | | | PV | PV | Butyral/ | Plast./ |
|---|---|---|---|---|---|---|
| Sub-film | | Tg PVB, | alcohol/% | acetate/ | % by | % by |
| A or C | PVB | DIN [° C.] | by weight | mol % | weight | weight |
| B1 | 1 | 74.9 | 20 | 1 | 78.7 | 27.5 |
| A1 | 2 | 65.2 | 11.9 | 7.2 | 78.9 | 30.8 |
| A2 | 2 | 65.2 | 11.9 | 7.2 | 78.9 | 24.15 |
| A3 | 2 | 65.2 | 11.9 | 7.2 | 78.9 | 17.42 |
| A4 | 2 | 65.2 | 11.9 | 7.2 | 78.9 | 25.4 |
| A5 | 2 | 65.2 | 11.9 | 7.2 | 78.9 | 25.1 |
| A6 | 2 | 65.2 | 11.9 | 7.2 | 78.9 | 25.05 |
| A7 | 2 | 65.2 | 11.9 | 7.2 | 78.9 | 37.5 |

TABLE 2

| | | Layer thickness | Plasticiser content sub- |
|---|---|---|---|
| | Sub-film | [mm] | layer B/% by weight |
| Example | layer structure | A/B/A | after 10 weeks |
| 1 | A1/B1/A1 | 0.375/0.2/0.375 | 36.5 |
| 2 | A2/B1/A2 | 0.36/0.125/0.36 | 38.1 |
| 3 | A3/B1/A3 | 0.36/0.125/0.36 | 36.2 |
| 4 | A4/B1/A4 | 0.32/0.2/0.32 | 36.1 |
| 5 | A5/B1/A5 | 0.33/0.175/0.33 | 36.6 |
| 6 | A6/B1/A6 | 0.44/0.225/0.44 | 36.1 |
| Comp. 1 | A7/B1/A7 | 0.36/0.125/0.36 | 39.1 |
| Comp. 2 | B1 | 0.76 | 27.5 |

TABLE 3

| | Loss factor of the 2nd mode with frequency | | | | | | |
|---|---|---|---|---|---|---|---|
| | in [Hz] at different temperatures 2 h after autoclave | | | | | | Total |
| | | Loss | | Loss | | Loss | plast. |
| | | factor | | factor | | factor | % by |
| Example | [Hz] | 10° C. | [Hz] | 20° C. | [Hz] | 30° C. | weight |
| 1 | 1175 | 0.08 | 1014 | 0.25 | 752 | 0.4 | 27 |
| 2 | 1162 | 0.07 | 1021 | 0.24 | 752 | 0.4 | 27 |
| 3 | 1173 | 0.05 | 1061 | 0.18 | 816 | 0.39 | 26 |
| 4 | 1125 | 0.06 | 1004 | 0.25 | 738 | 0.43 | 27 |
| 5 | 1156 | 0.07 | 1005 | 0.24 | 742 | 0.39 | 27 |
| 6 | 1169 | 0.08 | 1013 | 0.25 | 748 | 0.41 | 27 |
| Comp. 1 | 1092 | 0.13 | 901 | 0.32 | 652 | 0.31 | 29 |
| Comp. 2 | 1158 | 0.026 | 1094 | 0.068 | 966 | 0.19 | 27.5 |

TABLE 4

| | Loss factor of the 2nd mode with frequency | | | | | | |
|---|---|---|---|---|---|---|---|
| | in [Hz] at different temperatures after 10 weeks | | | | | | Total |
| | | Loss | | Loss | | Loss | plast. |
| | | factor | | factor | | factor | % by |
| Example | [Hz] | 10° C. | [Hz] | 20° C. | [Hz] | 30° C. | weight |
| 1 | 1086 | 0.18 | 841 | 0.38 | 634 | 0.31 | |
| 2 | 1050 | 0.2 | 801 | 0.40 | 628 | 0.29 | 27 |
| 3 | 1086 | 0.17 | 874 | 0.35 | 661 | 0.34 | 26 |
| 4 | 1050 | 0.16 | 842 | 0.37 | 624 | 0.35 | 27 |
| 5 | 1058 | 0.18 | 812 | 0.38 | 618 | 0.32 | 27 |
| 6 | 1086 | 0.17 | 826 | 0.40 | 619 | 0.33 | 27 |
| Comp. 1 | 950 | 0.27 | 712 | 0.37 | 604 | 0.22 | 29 |
| Comp. 2 | 1158 | 0.026 | 1094 | 0.068 | 966 | 0.19 | 27.5 |

TABLE 5

| | Loss factor of the 1st mode with | | | | |
|---|---|---|---|---|---|
| | frequency in [Hz] | | | | |
| | at 20° C. | | | | Ball-drop test in acc. with ECE-43 |
| | | | | After 10 | with 2 mm glass (sheet 30 × 30 cm) |
| | | 2 h after | | weeks of | and a film layer |
| Example | [Hz] | autoclave | [Hz] | storage | Drop height at 20° C. |
| 1 | 195 | 0.17 | 168 | 0.34 | 6.75 |
| 2 | 191 | 0.15 | 161 | 0.32 | 5.75 |
| 3 | 196 | 0.11 | 173 | 0.27 | 6.25 |
| 4 | 193 | 0.17 | 170 | 0.25 | 5.50 |
| 5 | 191 | 0.16 | 164 | 0.32 | 5.50 |
| 6 | 196 | 0.17 | 167 | 0.35 | 7.50 |
| Comp. 1 | 171 | 0.25 | 148 | 0.31 | 5.00 |
| Comp. 2 | 195 | 0.027 | 195 | 0.027 | 5.50 |

1.-10. (canceled)

11. An intermediate layer film for laminated glazing, comprising at least one first sub-film and at least one second sub-film, both of plasticiser-containing polyvinyl acetal and each sub-film with different plasticiser content, wherein the plasticiser-containing polyvinyl acetal of the first sub-film has a polyvinyl alcohol content from 17 to 22% by weight, and the second sub-film comprises a plasticiser-containing polyvinyl acetal with a polyvinyl alcohol content from 11 to 14% by weight, and the intermediate layer film has a total plasticiser content of less than 28% by weight.

12. The intermediate layer film of claim 11, wherein a second sub-film is arranged between two first sub-films.

13. The intermediate layer film of claim 11, wherein the plasticiser-containing polyvinyl acetal first sub-film has a proportion of polyvinyl acetate groups of from 0.1 to 11 mol %.

14. The intermediate layer film of claim 12, wherein the plasticiser-containing polyvinyl acetal first sub-film has a proportion of polyvinyl acetate groups of from 0.1 to 11 mol %.

15. The intermediate layer film of claim 11, wherein the plasticiser-containing polyvinyl acetal second sub-film has a proportion of polyvinyl acetate groups of from 0.1 to 11 mol %.

16. The intermediate layer film of claim 12, wherein the plasticiser-containing polyvinyl acetal second sub-film has a proportion of polyvinyl acetate groups of from 0.1 to 11 mol %.

17. The intermediate layer film of claim 13, wherein the plasticiser-containing polyvinyl acetal second sub-film has a proportion of polyvinyl acetate groups of from 0.1 to 11 mol %.

18. The intermediate layer film of claim 14, wherein the plasticiser-containing polyvinyl acetal second sub-film has a proportion of polyvinyl acetate groups of from 0.1 to 11 mol %.

19. The intermediate layer film of claim 11, wherein a laminate produced from an intermediate layer film with a thickness of 0.76 mm and two glass panels 2 mm thick has a penetration strength in the ball drop according to ECE43 of at least 5.0 m.

20. The intermediate layer film according to claim 11, wherein the first sub-film has a plasticiser content from 20 to 27% by weight and the second sub-film has a plasticiser content from 30 to 38% by weight.

21. The intermediate layer film of claim 11, wherein the first and second sub-films have plasticiser contents differing by at most 5% by weight.

22. The intermediate layer film of claim 11, wherein a second sub-film with a thickness of 100-200 μm is arranged between two first sub-films of a thickness from 320 to 375 μm.

23. The intermediate layer film of claim 11, wherein the intermediate layer film is produced by coextrusion of the sub-films.

24. The intermediate layer film according to one of claim 11, wherein the intermediate layer film is produced by combining the sub-films.
